(19) United States
(12) Patent Application Publication
(10) Pub. No.: US 2014/0362390 A1
(43) Pub. Date: Dec. 11, 2014

(54) PRINT SETTING APPARATUS AND PRINT SETTING METHOD

(71) Applicants: KABUSHIKI KAISHA TOSHIBA, Tokyo (JP); TOSHIBA TEC KABUSHIKI KAISHA, Tokyo (JP)

(72) Inventors: Masami Takahata, Tokyo-to (JP); Mika Hirama, Tokyo-to (JP); Naoki Watanabe, Tokyo-to (JP); Tomonori Ikumi, Numazu-shi (JP)

(73) Assignees: KABUSHIKI KAISHA TOSHIBA, Tokyo (JP); TOSHIBA TEC KABUSHIKI KAISHA, Tokyo (JP)

(21) Appl. No.: 14/295,526

(22) Filed: Jun. 4, 2014

(30) Foreign Application Priority Data
Jun. 7, 2013 (JP) 2013-121201

(51) Int. Cl. G06F 3/12

(52) U.S. Cl. CPC G06F 3/1254; G06F 3/1204; G06F 3/1257
USPC 358/1.9

(57) ABSTRACT

In accordance with one embodiment, a print setting apparatus comprises an operation section and a control section. The operation section accepts the selection on the content to be printed. The control section acquires the printing attribute of the content to be printed selected with the operation section. Further, the control section indicates a print setting based on the printing attribute of the content to a printing apparatus for printing the content.

### CROSS-REFERENCE TO RELATED APPLICATION

This application is based upon and claims the benefit of priority from Japanese Patent Application No. 2013-121201, filed Jun. 7, 2013, the entire contents of which are incorporated herein by reference.

### FIELD

Embodiments described herein relate to a print setting apparatus and a print setting method.

### BACKGROUND

A print setting apparatus prints a pre-stored document and the other contents according to the instruction of the user. When printing content, the print setting apparatus carries out a print setting involving the size of a sheet, a printing position and so on. In the past, in the use of a printing apparatus for printing a content selected by the user from pre-registered contents, as the user cannot master the detail of the content to be printed inmost cases, it is difficult for all the users to print the content according to a proper print setting.

### BRIEF DESCRIPTION OF THE DRAWINGS

FIG. 1 is a block diagram exemplifying the configuration of a print setting apparatus according to an embodiment;

FIG. 2 is a table exemplifying a print setting according to the embodiment;

FIG. 3 is a diagram exemplifying a content attribute table stored in the content attribute database (DB) of the print setting apparatus according to the embodiment;

FIG. 4 is a diagram exemplifying a project attribute table stored in the project DB of the print setting apparatus according to the embodiment;

FIG. 5 is a flowchart illustrating an action example of the storage of the attributes of a document in a content attribute table by the print setting apparatus according to the embodiment;

FIG. 6 is a flowchart illustrating another action example of the storage of the attributes of a document in a content attribute table by the print setting apparatus according to the embodiment;

FIG. 7 is a flowchart exemplifying the document printing action of the print setting apparatus according to the embodiment;

FIG. 8 is a flowchart exemplifying the storage of the attributes of a project in a project attribute table by the print setting apparatus according to the embodiment; and

FIG. 9 is a flowchart exemplifying the document printing action of the print setting apparatus according to the embodiment.

### DETAILED DESCRIPTION

According to embodiments described herein, a print setting apparatus comprises an operation section and a control section. The operation section accepts the selection on a content to be printed. The control section acquires the printing attribute of the content to be printed selected with the operation section. Further, the control section indicates a print setting based on the acquired printing attribute of the content to a printing apparatus for printing the content.

The print setting apparatus according to the embodiment prints a document or other contents according to an instruction of the user. The print setting apparatus can be any apparatus that is capable of indicating a print setting for a printing apparatus for printing the content. Further, it is set that the print setting apparatus has a function of executing the programs stored in a memory by a processor. For example, the print setting apparatus may be a multi-functional peripheral (MFP) or a personal computer (PC). In the case where the print setting apparatus is a PC, the print setting apparatus carries out a printing instruction to an external printing apparatus according to an instruction of the user. In embodiments described herein, an MFP is mainly described as the print setting apparatus.

The print setting apparatus is described below with reference to accompanying drawings.

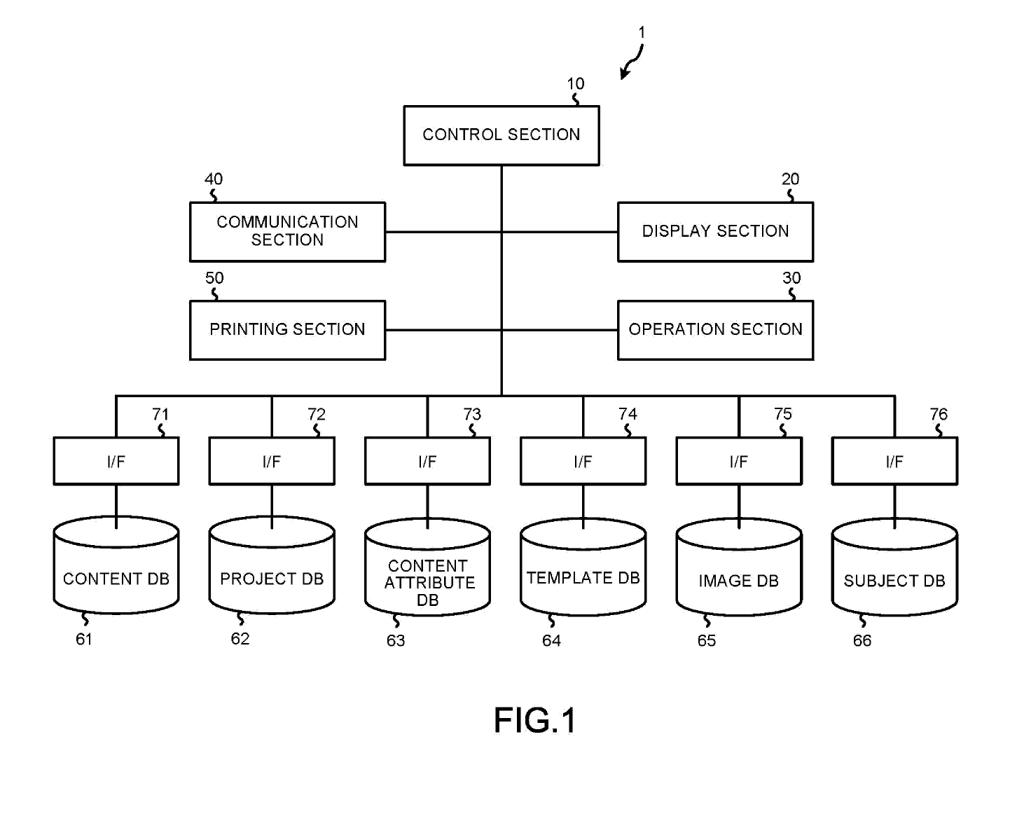

FIG. 1 is a block diagram exemplifying the configuration of a print setting apparatus 1 according to the embodiment.

As shown in FIG. 1, the print setting apparatus 1 comprises a control section 10, a display section 20, an operation section 30, a communication section 40, a printing section 50, a content DB 61, a project DB 62, a content attribute DB 63, a template DB 64, an image DB 65, a subject DB 66 and interfaces 71, 72, 73, 74, 75 and 76.

The control section 10 which controls the whole print setting apparatus 1 consists of a processor such as a CPU, various memories and various interfaces. The control section 10 is electrically connected with the display section 20, the operation section 30, the communication section 40, the printing section 50 and the interfaces 71-76.

For example, the control section 10 controls the display of the information to be indicated to the user on the display section 20. Further, the control section 10 executes on-demand printing applications (hereinafter referred to as applications). By executing the applications, the control section 10 controls the printing section 50 to print based on a printing instruction input by the user using the operation section 30.

The applications are programs for controlling the printing operation of the print setting apparatus 1. For example, an application is determined according to the installation environment of the print setting apparatus 1. For example, the application may also be an application corresponding to a place where the print setting apparatus 1 is installed and the installed use of the print setting apparatus 1.

Further, the control section 10 may store a plurality of applications which are used separately according to the instruction of the user.

The display section 20 displays various kinds of information for the user of the print setting apparatus 1. For example, according to an application, the display section 20 displays a screen for receiving the input of a printing instruction. The display section 20 is, for example, a liquid crystal display and the like.

The operation section 30 which is, for example, a keyboard and mouse receives the operation input by the user or operator of the print setting apparatus 1. The operation section 30 receives an input for operating an application. The operation 30 receives an operation of a screen transition and a document selection and the like. Further, the operation section 30 receives an operation for customizing a corresponding screen or function of an application. In this embodiment, the display section 20 and the operation section 30 are described with taking a touch panel as an example.

The communication section 40 is an interface communicating with an external device. For example, the communication section 40 may receive a content such as a document, an image such as a template or background or a subject from various external devices. The communication section 40 may also be an interface connected with an external network such as the Internet and the like. Further, the communication section 40 may be an interface connected with an Intranet such as a LAN.

The printing section 50 prints contents (e.g. document) according to an instruction from the control section 10. That is, the printing section 50 prints a to-be-printed image containing contents. The printing section 50 may also print a to-be-printed image sent from the control section 10. Further, the printing section 50 may also generate a to-be-printed image according to contents and a print setting sent from the control section 10, and then print the generated image.

The printing section 50 is not limited to be of a given type such as an inkjet or electrophotographic type.

The content DB 61 stores the content printed according to an instruction of the user. Here, the content DB 61 is set to be a database for storing document content. The content DB 61 pre-stores a printed document before the user instructs the print setting apparatus 1 to print. The content DB 61 may also store a document received from the communication section 40. Further, the content DB 61 may store a document input with the operation section 30. The document in the content DB 61 may be rewritten to the document obtained from the communication section 40 or the operation section 30. A plurality of documents may be stored in the content DB 61.

For example, the document in the content DB 61 may be a document constituting a coupon ticket or an admission ticket printed in a store. No specific limitation is given to the documents stored in the content DB 61 or the number thereof.

The project DB 62 stores a project attribute table, which will be described later.

The content attribute DB 63 stores a content attribute table, which will be described later.

The template DB 64 stores the templates used in the customization of an application. The template DB 64 may store a template in advance or add a template after the customization of an application. A plurality of templates may be stored in the template DB 64.

The image DB 65 stores the background image and element images used in the customization of an application. The image DB 65 may store each image in advance or add each image after the customization of an application.

The subject DB 66 stores a subject the information of which on application design, user interface and functions are defined. The subject DB 66 may store a subject in advance or add a subject after the customization of an application.

The interfaces 71-76 are interfaces for the control section 10 to acquire data from each DB. The interface 71 is an interface for the acquisition of content (here, referring to document) from the content DB 61 and the storage of the content in the content DB 61. The interface 72 is an interface for the acquisition of a project from the project DB 62 and the storage of the project in the project DB 62. The interface 73 is an interface for the acquisition of the attributes of content from the content attribute DB 63 and the storage of the attributes of the content in the content attribute DB 63. The interface 74 is an interface for the acquisition of a template from the template DB 64 and the storage of the template in the template DB 64. The interface 75 is an interface for the acquisition of each image from the image DB 65 and the storage of each image in the image DB 65. The interface 76 is an interface for the acquisition of a subject from the subject DB 66 and the storage of the subject in the subject DB 66.

Besides, the content DB 61, the project DB 62, the content attribute DB 63, the template DB 64, the image DB 65 and the subject DB 66 may be set in one recording device such as a hard disk or in a plurality of recording devices. Further, the content DB 61, the project DB 62, the content attribute DB 63, the template DB 64, the image DB 65 and the subject DB 66 may be set in the memory device of an external apparatus. In this case, the control section 10 acquires data from the external apparatus via the interfaces 71-76. Further, the interfaces 71-76 may be constituted to be capable of functioning as the communication section 40.

Next, an example of a print setting by the print setting apparatus 1 is described below.

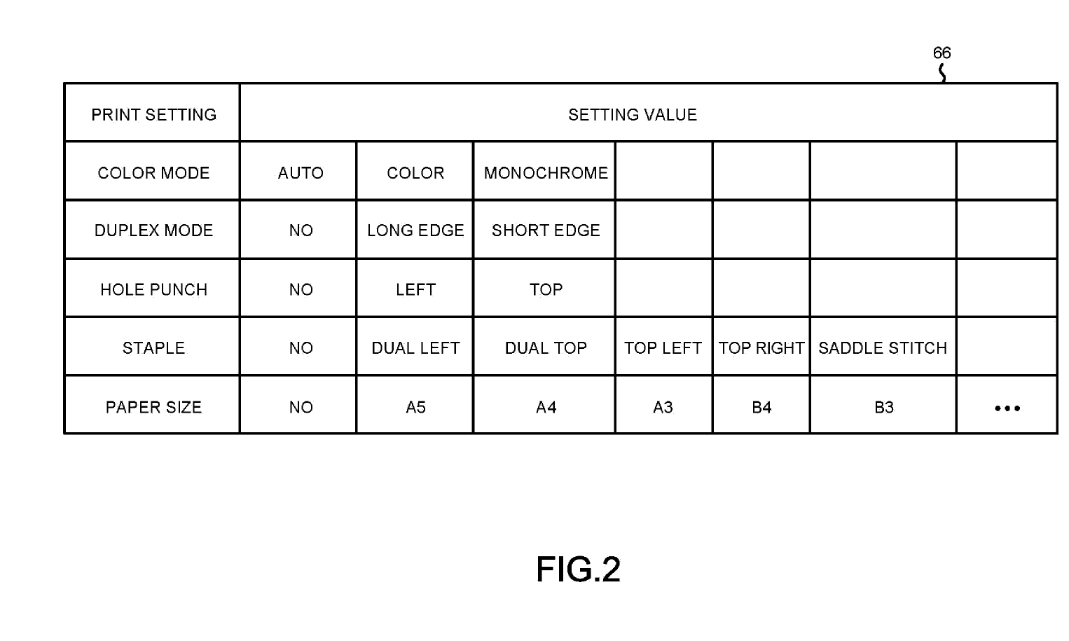

FIG. 2 exemplifies a subject table, that is, a table illustrating an example of a print setting, stored in the subject DB 66 according to the embodiment.

A print setting determines the printing form of content (e.g. document).

In the example shown in FIG. 2, a print setting consists of ‘Color mode’, ‘Duplex mode’, ‘Hole punch’, ‘Staple’, ‘Paper size’ and the like.

‘Color mode’ is a parameter for setting the color of a document to be printed. For example, ‘Color mode’ consists of ‘Automatic’, ‘Color’, ‘Monochrome’ and the like. ‘Automatic’ refers to a mode in which the color of a document is set according to the color information of the document. ‘Color’ refers to a mode in which a document is printed in color. ‘Monochrome’ refers to a mode in which a document is printed in monochrome.

‘Duplex mode’ is a parameter for setting a simplex printing mode or duplex printing mode for a document to be printed. ‘Duplex mode’ consists of ‘No’, ‘Long edge’ and ‘Short edge’. ‘No’ refers to a mode in which no duplex printing is carried out. ‘Long edge’ refers to a mode in which a duplex printing is carried out along a long edge. ‘Short edge’ refers to a mode in which a duplex printing is carried out along a short edge.

‘Hole punch’ is a parameter for setting whether or not a printing process can be carried out on a sheet in such a manner that holes can be punched on the sheet. ‘Hole punch’ consists of ‘No’, ‘Left’ and ‘Top’. ‘No’ refers to a mode in which a printing process is carried out on a sheet which is predefined not to be punched with a hole. ‘Left’ refers to a mode in which a printing process is carried out on a sheet in such a manner that a hole can be punched on the left side of the sheet. In the case where ‘Hole punch’ is ‘Left’, for example, the printing apparatus shifts the printing position on a sheet rightwards. ‘Top’ refers to a mode in which a printing process is carried out on a sheet in such a manner that a hole can be punched on the top of the sheet. In the case where ‘Hole punch’ is ‘Top’, for example, the printing apparatus shifts the printing position on a sheet downwards.

‘Staple’ is a parameter for setting whether or not a printing process can be carried out on a sheet in such a manner that the sheet can be stapled. ‘Staple’ consists of ‘No’, ‘Dual left’, ‘Dual top’, ‘Top left’, ‘Top right’ and ‘Saddle stitch’. ‘No’ refers to a mode in which a printing process is carried out on a sheet which is predefined not to be stapled. ‘Dual left’ refers to a mode in which a printing process is carried out on a sheet in such a manner that the sheet can be dually stapled on the left. ‘Dual top’ refers to a mode in which a printing process is carried out on a sheet in such a manner that the sheet can be dually stapled on the top. ‘Top left’ refers to a mode in which a printing process is carried out on a sheet in such a manner that the top left of the sheet is stapled. ‘Top right’ refers to a mode in which a printing process is carried out on a sheet in such a manner that the top right of the sheet can be stapled. ‘Saddle stitch’ refers to a mode in which a printing process is carried out on a sheet in such a manner that the sheet can be saddle-stitched.

‘Paper size’ designates the size of a sheet to be printed. As shown in FIG. 2, ‘Paper size’ may be ‘No’, ‘A5’, ‘A4’, ‘A3’, ‘B4’, ‘B3’ and the like.

The print setting may further include an item ‘Nin1’. No specific limitation is given to the items and the contents of the print setting.

The content attribute table is described below.

As stated above, the content attribute DB 63 stores a content attribute table, which indicates corresponding attributes of a document stored in the content DB 61.

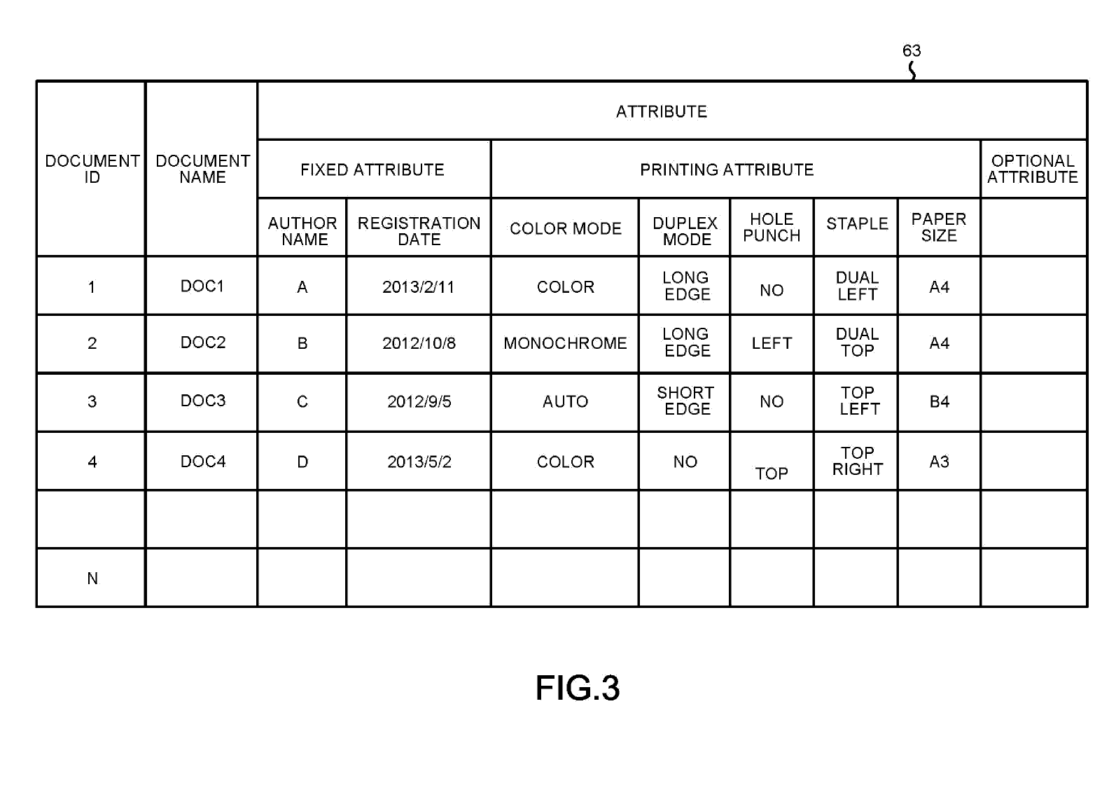

FIG. 3 shows an example of the content attribute table stored in the content attribute DB 63 according to the embodiment.

As shown in FIG. 3, the content attribute table stores a document ID, a document name, a fixed attribute, a printing attribute and an optional attribute in an associated manner.

The document ID refers to a fixed ID for specifying a document. The document name refers to the file name of a document.

The fixed attribute refers to attributes fixedly set for a document. As shown in FIG. 3, the fixed attribute consists of ‘author name’ and ‘registration date’. ‘Author name’ refers to the name of the author of a document. ‘Registration date’ refers to the storage date of a document in the content DB 51. For example, in the example shown in FIG. 3, the content attribute table indicates that for the document the document ID of which is ‘1’, the file name of the document is ‘doc1’, the name of the author of the document is ‘A’, and the registration date of the document is ‘2013/2/11’.

The printing attribute represents the print setting of a corresponding document. In the example shown in FIG. 3, the printing attribute consists of ‘Color mode’, ‘Duplex mode’, ‘Hole punch’, ‘Staple’ and ‘Paper size’, each of which is described above.

For example, in the example shown in FIG. 3, the content attribute table indicates that for the document the document ID of which is ‘1’, ‘Color mode’ is ‘Color’, ‘Duplex mode’ is ‘Long edge’, ‘Hole punch’ is ‘No’, ‘Staple’ is ‘No’ and ‘Paper size’ is ‘A4’.

Besides, the print setting may further include an item ‘Nin1’. No specific limitation is given to the elements of the printing attribute.

The optional attribute refers to an attribute optionally set for a corresponding document. The optional attribute is used to filter documents in an application. For example, the optional attribute may be an attribute representing the language of a document, such as ‘Japanese’.

The content attribute table stores attributes (the fixed attribute, the printing attribute and the optional attribute) for each document stored in the content DB 61. In the example shown in FIG. 3, the content attribute table stores attributes for n documents.

Besides, the content attribute table may further include other items. No specific limitation is given to the elements of the content attribute table.

The project attribute table is described below.

As stated above, the project DB 62 stores a project attribute table which stores the attributes set for a project. The projects correspond to an application. That is, the project attribute table stores the attributes corresponding to an application.

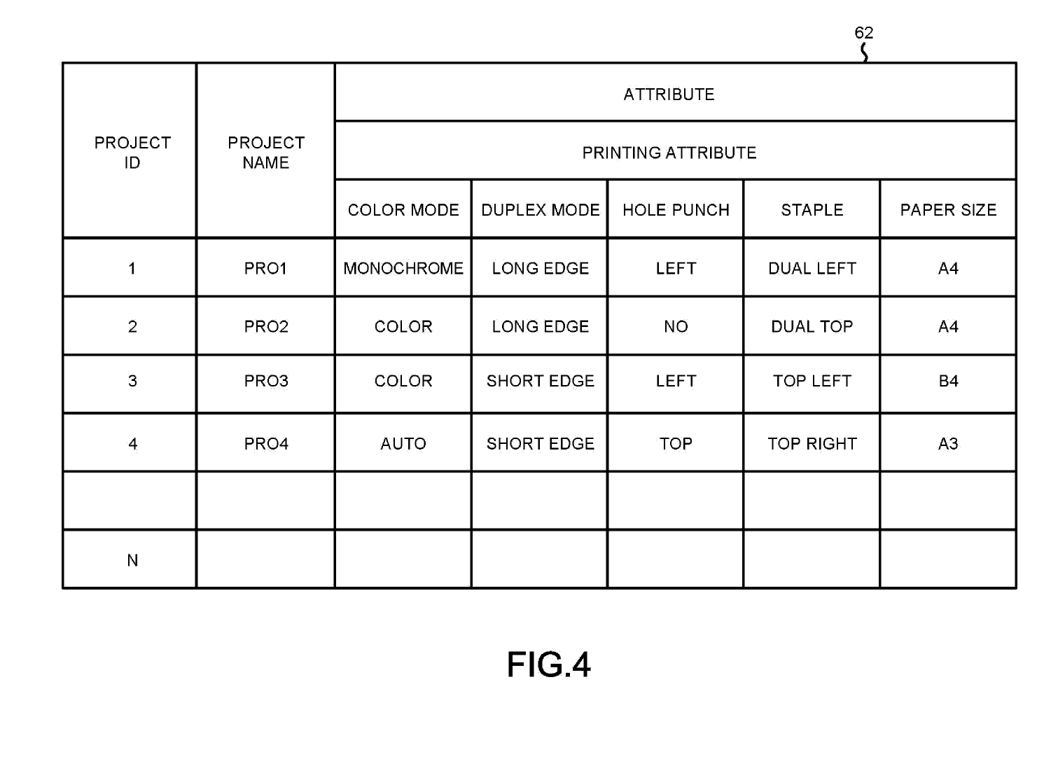

FIG. 4 shows an example of the project attribute table stored in the project DB 62.

As shown in FIG. 4, the project attribute table stores ‘project ID’, ‘project name’ and ‘attribute’ in an associated manner.

The project ID is a fixed ID for specifying a project. The project name is the name of a project. In the example shown in FIG. 4, for example, the project attribute table indicates that for the project the project ID of which is ‘1’, the name of the project is ‘prol’.

The attribute consists of a printing attribute which is the same as that contained in the content attribute table. In the example shown in FIG. 4, the project attribute table indicates that for the project the project ID of which is ‘1’, ‘Color mode ’ is ‘Monochrome’, ‘Duplex mode’ is ‘Long edge’, ‘Hole punch’ is ‘Left’, ‘Staple’ is ‘Dual left’ and ‘Paper size’ is ‘A4’.

Herein, the project attribute table stores n projects. Further, the number of the projects stored in the project attribute table is equal to or smaller than that of the applications stored in the control section 10.

Further, the project attribute table may further include other attributes (e.g. optional attribute) excluding the printing attribute. No specific limitation is given to the elements of the project attribute table.

Next, an example of printing a document by the control section 10 of the print setting apparatus 1 using the content attribute table is exemplified.

First, the setting of attributes for a document stored in the content DB 61 is described.

Additionally, the content attribute table refers here to a table which stores the document ID and the document name of a corresponding document when the document is stored in the content DB 61.

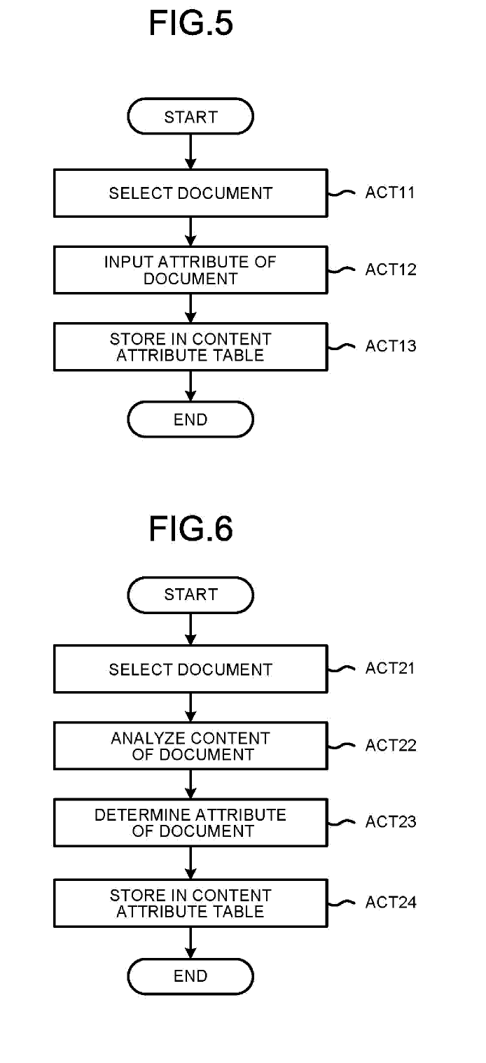

FIG. 5 is a flowchart exemplifying the setting of attributes for a document.

First, the control section 10 accepts an operation of selecting a document by the user using the operation section 30 (ACT 11). If the operation section 30 consists of a touch panel arranged on the screen of the display section 20, the control section 10 may enable the operator to touch (select) a document the attribute of which is to be set from a list of documents displayed on the display section 20.

When accepting the operation of selecting a document by an operator, the control section 10 accepts an operation of setting the attributes by the operator (ACT 12). That is, a fixed attribute, a printing attribute and an optional attribute are input by the operator in the operation section 30.

When accepting the operation of setting the attributes from the operator, the control section 10 instructs the interface 73 to additionally store the attributes of the document in the content attribute table stored in the content attribute DB 63 (ACT 13). That is, the control section 10 instructs the interface 73 to additionally store the attributes input in ACT 12 and a document ID representing the document selected in ACT 11 in an associated manner in the content attribute table.

Next, the automatic setting of attributes for a document is described.

FIG. 6 is a flowchart illustrating an example of the automatic setting of attributes for a document.

First, the control section 10 receives information of a document selected by the operator from the operation section 30 (ACT 21).

After receiving the operation of selecting the document by the operator, the control section 10 analyzes the document (ACT 22). For example, the control section 10 acquires the page number of the document. Further, the control section 10 may carry out an OCR processing for the document. In this case, the control section 10 recognizes the font size, the language and the like of the document. Additionally, no specific limitation is given to the document analysis of the control section 10.

In analyzing the document, the control section 10 determines attributes of the document according to the result of the analysis (ACT 23). For example, the control section 10 may recognize an author name according to the result of the OCR processing and determines the determined author name as the fixed attribute of the document. Further, the control section 10 may also determine an attribute ‘Nin1’ as a printing attribute according to the page number of the document. For example, if the page number is greater than 10, the control section 10 determines the printing attribute ‘Nin1’ as 2in1. Further, the control section 10 may determine Nin1 according to the font size of the characters subjected to the OCR processing. For example, in the case where the font size is below 9-point font, the control section 10 may determine a print setting ‘no Nin1’ as a printing attribute. Further, if the language of the document is English, the control section 10 may also determine ‘English’ as an optional attribute. No specific limitation is given to the attributes determined by the control section 10 according to the result of the analysis. Further, the control section 10 may display the attributes determined according to the result of the analysis of a document on the display section 20. In this case, the operation section 30 may accept the modification of the displayed attributes by the operator.

When the attributes of the document are determined, the control section 10 registers (stores) information representing the determined attributes of the document in the content attribute table stored in the content attribute DB 63 via the interface 73 (ACT 24). Attributes may be stored every time the content DB 61 stores a document. Further, the attributes of a document may be updated during the running process of the print setting apparatus 1.

Next, the printing of a document using the content attribute table is described.

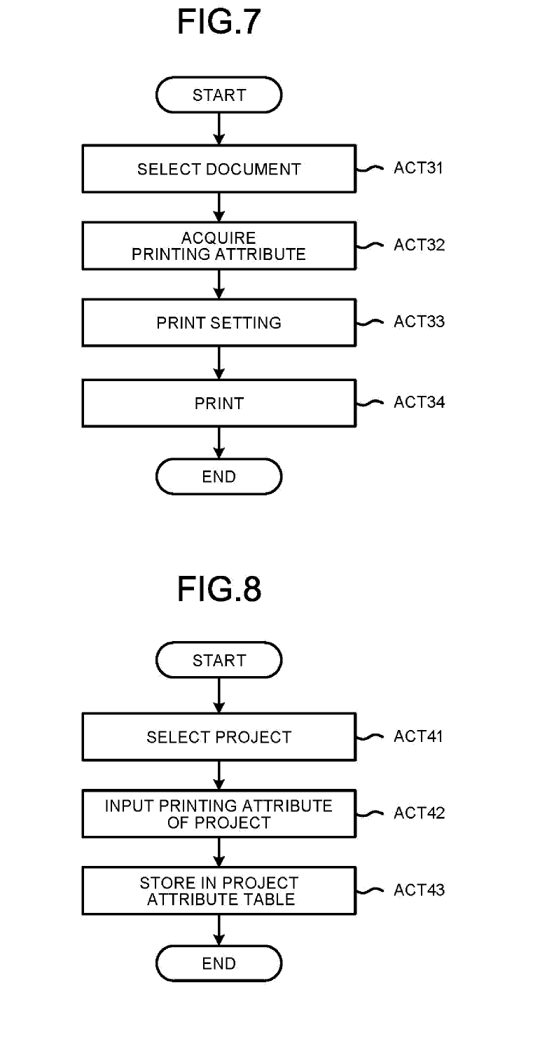

FIG. 7 is a flowchart exemplifying the printing of a document using the content attribute table.

First, the control section 10 accepts an operation of selecting a document to be printed by the operator using the operation section 30 (ACT 31).

When accepting the operation of selecting a document, the control section 10 acquires, with reference to the content attribute table, a printing attribute as a print setting for the document (ACT 32). That is, the control section 10 instructs the interface 73 to acquire a printing attribute corresponding to the document ID of the document selected in ACT 31 from the content attribute table stored in the content attribute DB 63. When acquiring the printing attribute of the document, the control section 10 generates print setting information based on attributes (printing attribute) of the document (ACT 33).

When generating the print setting information based on the printing attribute of the document, the control section 10 instructs the printing section 50 to print the corresponding document according to the print setting (ACT 34). For example, in a case of sending image data to be printed to the printing section 50, the control section 10 sends the image data to be printed which is generated according to the print setting information to the printing section 50 along with a printing instruction. In this case, the printing section 50 carries out a printing process according to the image data to be printed fed from the control section 10. Further, in the case where an image to be printed is generated by the printing section 50, the control section 10 sends the data of the document and the print setting information to the printing section 50 along with a printing instruction. The printing section 50 generates the image to be printed according to the print setting information and the data of the document and prints the generated image to be printed on a sheet.

Next, the printing of a document by the control section 10 using the project attribute table is described.

First, an example of the setting of attributes for the projects corresponding to an application is described.

FIG. 8 is a flowchart exemplifying the setting of attributes for the projects corresponding to an application.

First, the control section 10 accepts an operation of selecting a project by the operator using the operation section 30 (ACT 41). Further, the control section 10 may further accept an operation of re-creating a project. In this case, the operator sets attributes of the re-created project. When receiving the operation of selecting the project by the operator, the control section 10 accepts an operation of setting attributes from the operator (ACT 42).

When accepting the operation of setting attributes from the operator, the control section 10 instructs the interface 72 to register (store) the attributes of the project in the project attribute table stored in the project DB 62 (ACT 43).

Further, attributes may be stored every time an application is added in the control section 10. The attributes of a project may be updated during the running process of the print setting apparatus 1.

Next, the printing of a document using the project attribute table is described.

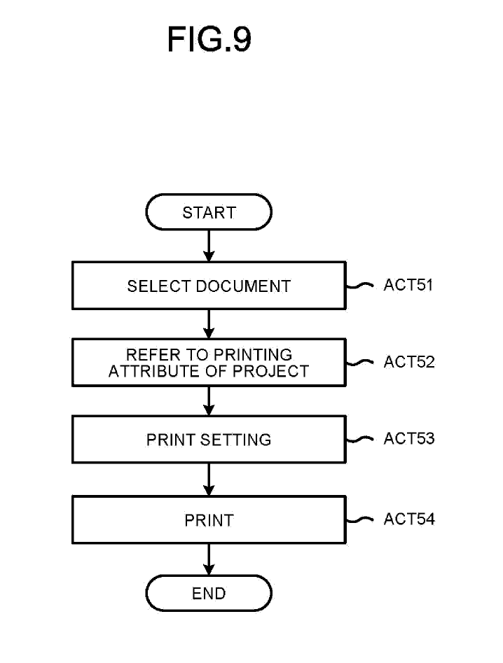

FIG. 9 is a flowchart exemplifying the printing of a document using the project attribute table.

First, the control section 10 accepts an operation of selecting a to-be-printed document by the operator using the operation section 30 (ACT 51).

When accepting the operation of selecting a document, the control section 10 acquires, by referring to the project attribute table, a printing attribute representing a print setting for the document (ACT 52). That is, the control section 10 specifies the application being executed as well as the projects corresponding to the specified application. After specifying the projects, the control section 10 acquires, via the interface 72, a printing attribute corresponding to the project ID of the specified project from the project attribute table stored in the project DB 62.

When acquiring the printing attribute of the document, the control section 10 generates print setting information based on the printing attribute of the document (ACT 53). The control section 10 instructs the printing section 50 to print the document based on the print setting information (ACT 54).

Besides, the print setting apparatus 1 may carry out a printing operation using either of the content attribute table and the project attribute table.

Further, the print setting apparatus 1 may carry out a printing operation using both the content attribute table and the project attribute table. In this case, the print setting apparatus 1 may preferentially acquire a printing attribute from the content attribute table aiming at the print setting of a specific document and acquire printing attributes from the project attribute table aiming at print settings of other documents. Further, the content DB 61 may store other contents excluding document as content. For example, the content DB 61 may store an image and the like as content.

In this embodiment, the functions of the present invention are prerecorded in the apparatus, however, the present invention is not limited to this, the same functions may also be downloaded to the apparatus from a network or stored in a recording medium and then installed in the apparatus. The recording medium may be any recording medium (e.g. CD-ROM) that is capable of storing programs and readable to the apparatus. Further, the functions realized by an installed or downloaded program can also be realized by the cooperation with an OS (Operating System) in the apparatus.

Thus, a print setting program enables the print setting apparatus 1 to achieve: a function of acquiring content; a function of accepting the selecting of content to be printed; a function of acquiring a printing attribute as a print setting for a content; and a function of indicating the print setting based on the printing attribute of the acquired content for a printing apparatus for printing the content.

According to the print setting apparatus having the aforementioned structure, the user can print content according to a pre-registered printing attribute without making a print setting in a case of a printing process. As a result, the print setting apparatus can carry out a printing processing according to the attributes of the content even if no detailed print setting is made by the user.

For example, in the case where the content selected by the user (e.g. an unspecified user) from pre-registered contents is printed, the user himself/herself who is required to print content can print the content according to a print setting corresponding to the attributes of the content even if the user fails to master details of the content. That is, the print setting apparatus according to the embodiment can provide a printing of content according to a print setting corresponding to a pre-registered printing attribute even if the user who is required to print the content makes no detailed print setting.

The print setting apparatus with the aforementioned structure selects a document (content) to be registered, analyzes the content of the selected document, determines the attributes of the document selected according to a given condition (rule) based on the result of the analysis and registers the determined attributes of the document in a database. In this way, the print setting apparatus according to the embodiment can be efficiently used and managed while none of the attributes of a to-be-registered content relevant to a print setting is manually input by the manager.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A print setting apparatus, comprising:
an operation section configured to accept the selection on the content to be printed; and
a control section configured to acquire the printing attribute of the content to be printed selected with the operation section and indicate a print setting based on the obtained printing attribute of the content to a printing apparatus for printing the content.

2. The print setting apparatus according to claim 1, further comprising:
a printing attribute storage section for storing the printing attribute, wherein
the control section accesses the printing attribute storage section.

3. The print setting apparatus according to claim 1, comprising:
a printing section serving as a printing apparatus configured to print the content based on the print setting indicated by the control section.

4. The print setting apparatus according to claim 1, wherein
the control section analyzes the content, determines a printing attribute according to a given condition based on the result of the analysis on the content and registers the determined printing attribute by the control section corresponding to the content.

5. A print setting method, including
accepting the selection on a content to be printed;
acquiring the printing attribute of the selected content to be printed; and
indicating a print setting based on the printing attribute of the acquired content to a printing apparatus for printing the content.

6. The print setting method according to claim 5, further including
analyzing the content;
determining a printing attribute according to a given condition based on the result of the analysis on the content; and
registering the determined printing attribute by the control section corresponding to the content.
